(19) United States
(12) Patent Application Publication
(10) Pub. No.: US 2025/0329759 A1
(43) Pub. Date: Oct. 23, 2025

(54) METHOD FOR DIAGNOSING SEALING STATE OF FUEL CELL AND FUEL CELL SYSTEM

(71) Applicant: TOYOTA JIDOSHA KABUSHIKI KAISHA, Toyota-shi (JP)

(72) Inventors: Junichi MATSUO, Okazaki-shi (JP); Masafumi SATO, Nagoya-shi (JP); Yoshiaki OTO, Nagoya-shi (JP)

(73) Assignee: TOYOTA JIDOSHA KABUSHIKI KAISHA, Toyota-shi (JP)

(21) Appl. No.: 19/034,622

(22) Filed: Jan. 23, 2025

(30) Foreign Application Priority Data
Apr. 18, 2024 (JP) 2024-067327

(51) Int. Cl. H01M 8/0438; H01M 8/043; H01M 8/04664; H01M 8/04746

(52) U.S. Cl. CPC H01M 8/04432; H01M 8/043; H01M 8/04664; H01M 8/04753

(57) ABSTRACT

In a method for diagnosing a sealing state of a fuel cell, before stopping the fuel cell, the inside of the fuel cell is pressurized to a predetermined pressure higher than the atmospheric pressure by supplying the anode gas to the fuel cell, and while the fuel cell is stopped, the sealing state in which the anode gas inlet and outlet and the cathode gas inlet and outlet of the fuel cell are sealed is maintained, and the internal pressure of the fuel cell measured before restarting of the fuel cell is compared with the atmospheric pressure, thereby determining whether the sealing state is good.

### CROSS-REFERENCE TO RELATED APPLICATION

This application claims priority to Japanese Patent Application No. 2024-067327 filed on Apr. 18, 2024, incorporated herein by reference in its entirety.

### BACKGROUND

### 1. Technical Field

The present disclosure relates to methods for diagnosing a sealing state of a fuel cell and fuel cell systems.

### 2. Description of Related Art

A method is known in which, when a fuel cell is stopped, control valves for gas channels are closed to detect cross leakage, namely permeation of a reaction gas across an electrolyte membrane (for example, Japanese Unexamined Patent Application Publication No. 2022-162240 (JP 2022-162240 A)).

### SUMMARY

If a cathode gas inlet and outlet and an anode gas inlet and outlet are not properly sealed while a fuel cell is stopped, it may lead to degradation of the fuel cell. Therefore, there is a demand for a technique of diagnosing whether a cathode gas inlet and outlet and an anode gas inlet and outlet of a fuel cell are properly sealed.

The present disclosure can be implemented in the following forms.

A first aspect of the present disclosure provides a method for diagnosing a sealing state of a fuel cell. The method for diagnosing a sealing state of a fuel cell includes:

before stopping the fuel cell, compressing inside of the fuel cell to a predetermined pressure higher than an atmospheric pressure by supplying an anode gas to the fuel cell;
while the fuel cell is stopped, maintaining the sealing state in which an anode gas inlet and outlet of the fuel cell and a cathode gas inlet and outlet of the fuel cell are sealed; and
determining whether the sealing state is good by comparing a pressure inside the fuel cell measured before restarting the fuel cell with the atmospheric pressure.

According to the method of this aspect, whether the cathode gas inlet and outlet of the fuel cell and the anode gas inlet and outlet of the fuel cell are properly sealed can be diagnosed.

In the method of the above aspect,

the predetermined pressure may be such a pressure that a pressure of a cathode gas internal channel and a pressure of an anode gas internal channel are higher than the atmospheric pressure when the sealing state is good and the pressure of the cathode gas internal channel and the pressure of the anode gas internal channel are in equilibrium, the cathode gas internal channel and the anode gas internal channel being channels provided inside the fuel cell,
when the pressure inside the fuel cell measured before restarting the fuel cell is higher than the atmospheric pressure, determination may be made that the sealing state is good, and
when the pressure inside the fuel cell measured before restarting the fuel cell is not higher than the atmospheric pressure, determination may be made that the sealing state is not good.

The method of the above aspect can reduce erroneous determination that the sealing state is not good even though the sealing state is actually good.

A second aspect of the present disclosure provides a fuel cell system. The fuel cell system includes:

a fuel cell;
an anode gas supply source configured to supply an anode gas to the fuel cell;
a plurality of valves configured to seal an anode gas inlet and outlet of the fuel cell and a cathode gas inlet and outlet of the fuel cell;
a pressure sensor configured to measure a pressure inside the fuel cell; and
a control device configured to control the valves.

The control device is configured to

before stopping the fuel cell, compress inside of the fuel cell to a predetermined pressure higher than an atmospheric pressure by supplying the anode gas from the anode gas supply source to the fuel cell,
while the fuel cell is stopped, close the valves to maintain a sealing state in which the anode gas inlet and outlet of the fuel cell and the cathode gas inlet and outlet of the fuel cell are sealed, and
determine whether the sealing state is good by comparing the pressure inside the fuel cell measured with the pressure sensor before restarting the fuel cell with the atmospheric pressure.

According to the fuel cell system of this aspect, whether the cathode gas inlet and outlet of the fuel cell and the anode gas inlet and outlet of the fuel cell are properly sealed can be diagnosed.

The present disclosure can also be implemented in various forms other than the method for diagnosing a sealing state of a fuel cell and the fuel cell system. For example, the present disclosure can be implemented in the form of a method for diagnosing an abnormality in a fuel cell system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a first illustration showing a configuration of a fuel cell system;

FIG. 2 is a second illustration showing a configuration of a fuel cell system;

FIG. 3 is an illustration showing a configuration of a control device;

FIG. 4 is a flowchart of a procedure of a method for diagnosing a sealing state of a gas inlet and outlet;

FIG. 5 is an illustration showing the internal pressure of the fuel cell when the sealing state of the gas inlet and outlet is good; and

FIG. 6 is an illustration showing the internal pressure of the fuel cell when the sealing state of the gas inlet and outlet is not good.

### DETAILED DESCRIPTION OF EMBODIMENTS

### A. First Embodiment

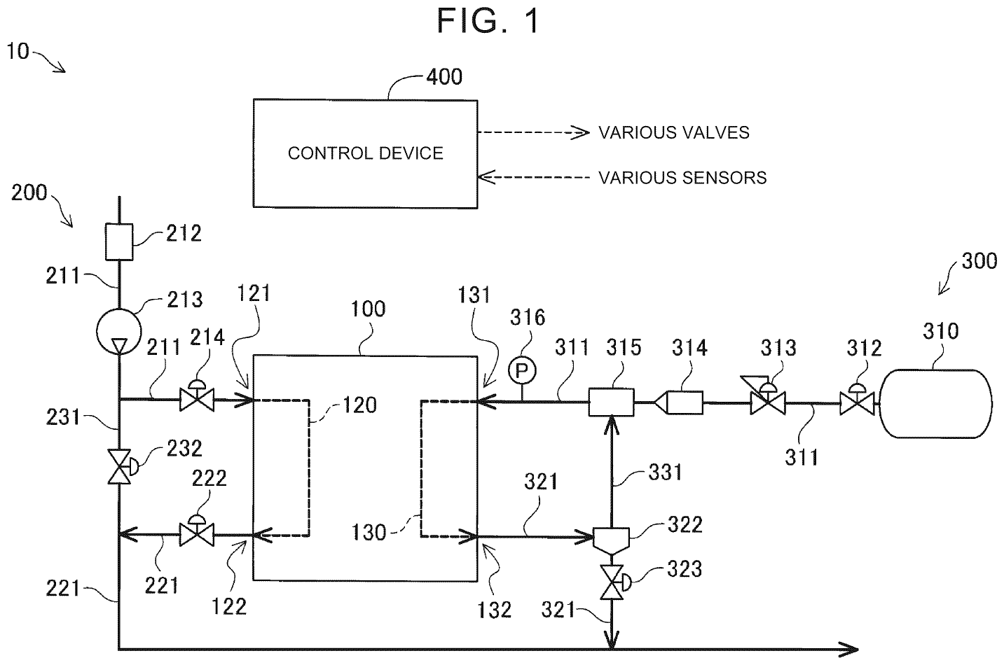

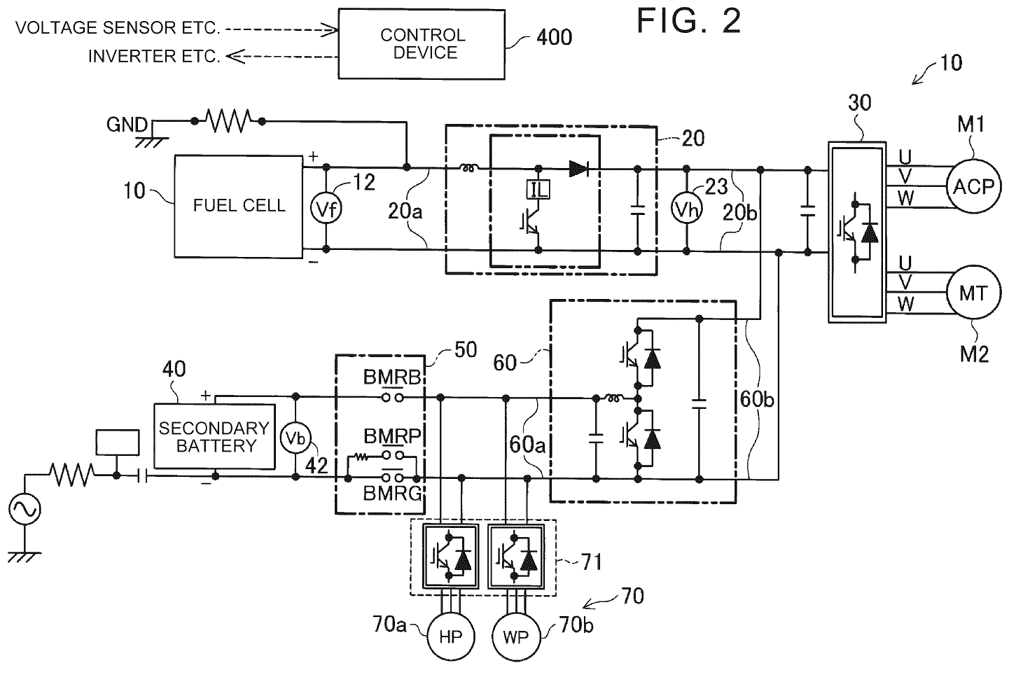

FIG. 1 is a first illustration showing a configuration of a fuel cell system 10 according to a first embodiment. FIG. 2 is a second illustration showing a configuration of the fuel cell system 10 according to the first embodiment. The fuel cell system 10 according to the present embodiment is mounted on a fuel cell electric vehicle (FCEV: Fuel Cell Electric Vehicle). However, the fuel cell system 10 may not be mounted on fuel cell electric vehicle, and may be, for example, a stationary type. As illustrated in FIG. 1, the fuel cell system 10 includes a fuel cell 100, a cathode gas supply/discharge system 200, an anode gas supply/discharge system 300, and a control device 400.

The fuel cell 100 generates electricity by an electrochemical reaction between the anode gas and the cathode gas. In the present embodiment, the fuel cell 100 is a polymer electrolyte fuel cell, in which hydrogen gas is used as an anode gas and air is used as a cathode gas. However, a fuel cell other than the polymer electrolyte fuel cell may be used as the fuel cell 100, or a gas other than hydrogen or air may be used as the anode gas or the cathode gas. The fuel cell 100 has a stacked structure in which a plurality of unit cells is stacked and a plurality of unit cells are connected in series. Each single cell includes a membrane electrode assembly having an electrode catalyst layer on both surfaces of an electrolyte membrane, and a pair of separators sandwiching the membrane electrode assembly.

The fuel cell 100 has a cathode gas internal channel 120 for supplying a cathode gas to the cathode side of the membrane electrode assembly of each unit cell, and an anode gas internal channel 130 for supplying an anode gas to the anode side of the membrane electrode assembly of each unit cell. The fuel cell 100 has a cathode gas inlet 121 for introducing cathode gas from the outside of the fuel cell 100 into the cathode gas internal channel 120, a cathode gas outlet 122 for discharging cathode off-gas from the cathode gas internal channel 120 to the outside of the fuel cell 100, an anode gas inlet 131 for introducing anode gas from the outside of the fuel cell 100 into the anode gas internal channel 130, and an anode gas outlet 132 for discharging anode off-gas from the anode gas internal channel 130 to the outside of the fuel cell 100. In the present disclosure, when the cathode gas inlet 121 and the cathode gas outlet 122 are described without particular distinction, these are referred to as cathode gas inlet and outlet. If the anode gas inlet 131 and the anode gas outlet 132 are described without particular distinction, these are referred to as anode gas inlet and outlet.

The cathode gas supply/discharge system 200 supplies the cathode gas to the cathode gas inlet 121 of the fuel cell 100, and discharges the cathode off-gas discharged from the cathode gas outlet 122 to the outside of the fuel cell system 10. In the following description, when the cathode gas and the cathode off-gas are described without being particularly distinguished from each other, these are referred to as cathode gases. In the present embodiment, the cathode gas supply/discharge system 200 includes a cathode gas supply channel 211, an air cleaner 212, a compressor 213, a cathode inlet valve 214, a cathode off-gas discharge channel 221, a cathode outlet valve 222, a bypass channel 231, and a bypass valve 232.

An upstream end portion of the cathode gas supply channel 211 communicates with the atmosphere, and a downstream end portion of the cathode gas supply channel 211 is connected to the cathode gas inlet 121 of the fuel cell 100. In the cathode gas supply channel 211, an air cleaner 212, a compressor 213, and a cathode inlet valve 214 are provided in this order from the upstream side. The air cleaner 212 collects foreign matter in the cathode gas. The compressor 213 pumps the cathode gas to the downstream side. The cathode inlet valve 214 regulates the flow rate of the cathode gas supplied to the cathode gas inlet 121. The cathode inlet valve 214 is constituted by, for example, an electrically operated valve or a solenoid valve.

An upstream end portion of the cathode off-gas discharge channel 221 is connected to the cathode gas outlet 122 of the fuel cell 100, and a downstream end portion of the cathode off-gas discharge channel 221 communicates with the atmosphere. A cathode outlet valve 222 is provided in the cathode off-gas discharge channel 221. The cathode outlet valve 222 regulates the flow rate of the cathode off-gas discharged from the cathode gas outlet 122. The cathode outlet valve 222 is constituted by, for example, an electrically 20 operated valve or a solenoid valve.

The bypass channel 231 is a channel for discharging the cathode gas from the cathode gas supply channel 211 to the cathode off-gas discharge channel 221 without passing through the fuel cell 100. An upstream end of the bypass channel 231 is connected to a portion of the cathode gas supply channel 211 between the compressor 213 and the cathode inlet valve 214. The downstream end of the bypass channel 231 is connected to a portion of the cathode off-gas discharge channel 221 between the cathode outlet valve 222 and the downstream end. A bypass valve 232 is provided in the bypass channel 231. The bypass valve 232 regulates the flow rate of the cathode gas passing through the bypass channel 231. The bypass valve 232 is constituted by, for example, an electric valve or a solenoid valve. The cathode gas supply/discharge system 200 may not include the bypass channel 231 and the bypass valve 232.

The anode gas supply/discharge system 300 supplies the anode gas to the anode gas inlet 131 of the fuel cell 100, and discharges the anode off-gas discharged from the anode gas outlet 132 of the fuel cell 100 to the outside of the fuel cell system 10. In the following description, when the anode gas and the anode off-gas are described without being particularly distinguished from each other, these are referred to as anode gas. In the present embodiment, the anode gas supply/discharge system 300 includes an anode gas tank 310, an anode gas supply channel 311, a main stop valve 312, a regulator 313, an anode inlet valve 314, an ejector 315, a pressure sensor 316, an anode off-gas discharge channel 321, a gas-liquid separator 322, an anode outlet valve 323, and a circulation channel 331.

The anode gas tank 310, which is an anode gas supply source, stores, for example, anode gas pressurized to 35 MPa or 70 MPa. An upstream end portion of the anode gas supply channel 311 is connected to the anode gas tank 310, and a downstream end portion of the anode gas supply channel 311 is connected to the anode gas inlet 131 of the fuel cell 100. In the anode gas supply channel 311, a main stop valve 312, a regulator 313, an anode inlet valve 314, an ejector 315, and a pressure sensor 316 are provided in this order from the upstream side. The main stop valve 312 regulates the flow rate of the anode gas supplied from the anode gas tank 310. The main stop valve 312 is constituted by, for example, an electrically operated valve or a solenoid valve. The regulator 313 reduces the pressure of the anode gas supplied from the main stop valve 312 to the anode inlet valve 314. The anode inlet valve 314 regulates the flow rate of the anode gas supplied to the anode gas inlet 131. The anode inlet valve 314 is constituted by, for example, a solenoid valve for injecting anode gas. The ejector 315 supplies the anode gas injected from the anode inlet valve 314 to the anode gas inlet 131, and supplies the anode off-gas sucked from the circulation channel 331 to the anode gas inlet 131 by using the negative pressure generated by the jet of the anode gas. The pressure sensor 316 measures the pressure inside the anode gas supply channel 311. The opening and closing of the anode inlet valve 314 is controlled based on the pressure measured by the pressure sensor 316.

An upstream end portion of the anode off-gas discharge channel 321 is connected to the anode gas outlet 132 of the fuel cell 100. The downstream end portion of the anode off-gas discharge channel 321 is connected to a portion of the cathode off-gas discharge channel 221 downstream of the connection portion with the bypass channel 231. In the anode off-gas discharge channel 321, a gas-liquid separator 322 and an anode outlet valve 323 are provided in this order from the upstream side. The gas-liquid separator 322 separates the gas component and the liquid component contained in the anode off-gas. The anode outlet valve 323 regulates the flow rate of the gas component and the liquid component of the anode off-gas discharged from the gas-liquid separator 322 to the cathode off-gas discharge channel 221. The anode outlet valve 323 is constituted by an electrically operated valve or a solenoid valve.

An upstream end portion of the circulation channel 331 is connected to the gas-liquid separator 322, and a downstream end portion of the circulation channel 331 is connected to the ejector 315. The gas component of the anode off-gas stored in the gas-liquid separator 322 is sucked into the ejector 315, and is thus supplied to the anode gas supply channel 311 via the circulation channel 331. It should be noted that the anode gas supply/discharge system 300 may not be provided with the ejector 315, and a pump for feeding the gas component of the anode off-gas from the gas-liquid separator 322 to the anode gas supply channel 311 may be provided. The anode gas supply/discharge system 300 may not include the circulation channel 331.

As shown in FIG. 2, a voltage sensor 12 for measuring an output voltage Vf of the fuel cell 100 is provided at an output terminal of the fuel cell 100. The fuel cell 100 is connected to the fuel cell boost converter 20 via the primary-side wire 20a. The fuel cell boost converter 20 is a DC/DC converter, and boosts the output voltage Vf of the fuel cell 100. The fuel cell boost converter 20 is connected to the inverter 30 via the secondary-side wire 20b. The secondary-side wire 20b is provided with a voltage sensor 23 for measuring the output voltage Vh of the fuel cell boost converter 20. The DC power boosted by the fuel cell boost converter 20 is supplied to the inverter 30. Inverter 30 converts the DC power supplied from the DC power and the secondary battery 40 supplied from the fuel cell 100 into three-phase AC power, and supplies the motor M1 for driving the compressor 213 shown in FIG. 1, the motor M2 for driving the wheels of fuel cell electric vehicle. In the present embodiment, the fuel cell system 10 does not include a relay circuit for electrically connecting or disconnecting the fuel cell 100 and the load. The load is a device that consumes electric power of the fuel cell 100, and is, for example, motors M1, M2.

The secondary battery 40 is a chargeable and dischargeable battery, and is, for example, a lithium-ion secondary battery. The secondary battery 40 is electrically connected to the secondary battery boost converter 60 via the primary-side wire 60a. The primary-side wire 60a is provided with a secondary battery relay circuit 50 for electrically connecting and disconnecting the secondary battery 40 and the secondary battery boost converter 60. A voltage sensor 42 for measuring an output voltage Vb of the secondary battery 40 is provided in the primary-side wire 60a between the secondary battery 40 and the relay circuit 50 for the secondary battery. Auxiliary machines 70 are connected to the primary-side wire 60a between the secondary battery relay circuit 50 and the secondary battery boost converter 60 via a boost converter 71 that is a DC/DC converter. In the present embodiment, the auxiliary machines 70 include a plurality of auxiliary machines 70a, 70b. The plurality of auxiliary machines 70a, 70b include, for example, a coolant pump for circulating coolant for cooling the fuel cell 100. The secondary battery boost converter 60 is a DC/DC converter, and boosts the output voltage Vb of the secondary battery 40. The secondary battery boost converter 60 is connected to the secondary-side wire 20b between the fuel cell boost converter 20 and the inverter 30 via the secondary-side wire 60b. The circuit group from the secondary battery 40 to the secondary battery boost converter 60 is connected in parallel to the circuit group from the fuel cell 100 to the fuel cell boost converter 20. The DC power boosted by the secondary battery boost converter 60 is supplied to the inverter 30. Note that the secondary battery boost converter 60 can also step down the electric power of the fuel cell 100 and the regenerative electric power of the motor M2 to charge the secondary battery 40.

In the fuel cell system 10, a high voltage circuit including the fuel cell 100, a high voltage circuit including the secondary battery 40, and motors M1, M2 are insulated from external conductors provided outside the fuel cell system 10. Specifically, the outer conductor is a vehicle body of a fuel cell electric vehicle. The insulation resistance ideally has an infinite resistance value. However, for example, the insulation resistance may decrease due to damage to the insulating film of the wire. The insulation resistance Ri shown in FIG. 2 represents the insulation resistance between the positive side of circuitry of an FC area and the external conductor. FC area is a group of circuits from the fuel cell 100 to the fuel cell boost converter 20. In FIG. 2, the insulation resistance other than the insulation resistance Ri is not illustrated.

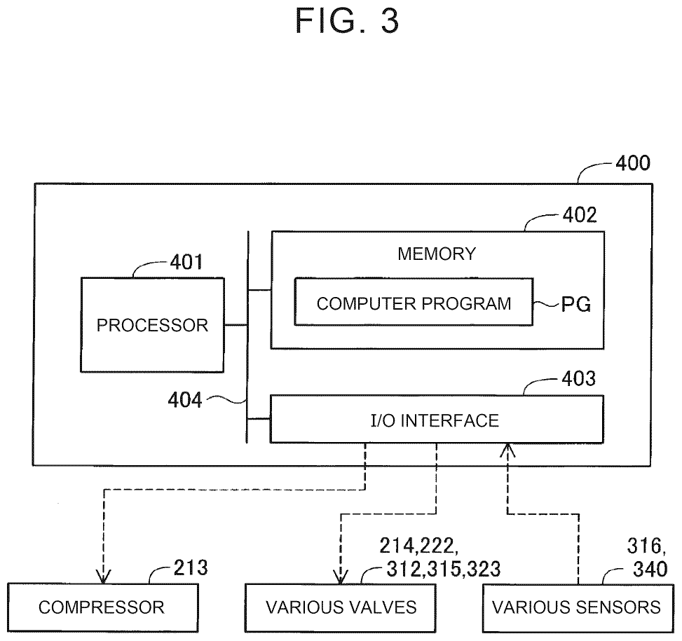

As illustrated in FIG. 3, the control device 400 includes a computer including a processor 401, a memory 402, an input/output interface 403, and an internal bus 404. The processor 401, the memory 402, and the input/output interface 403 are bidirectionally communicably connected to each other via an internal bus 404. The input/output interface 403 is connected to a compressor 213, various valves including a cathode inlet valve 214, a cathode outlet valve 222, a bypass valve 232, a main stop valve 312, an anode inlet valve 314, and an anode outlet valve 323, and various sensors including a pressure sensor 316 and an atmospheric pressure sensor 340 via wired communication or wireless communication. The atmospheric pressure sensor 340 measures the atmospheric pressure around the fuel cell system 10. Although not shown, the voltage sensors 12, 23, and 42, the fuel cell boost converter 20, the inverter 30, the secondary battery boost converter 60, and the like are further connected to the input/output interface 403 via wired communication or wireless communication.

The processor 401 performs various functions including a function of controlling the operation of the fuel cell 100 by executing a computer program PG stored in advance in the memory 402, and a function of diagnosing the sealing state of the cathode gas inlet and outlet and the anode gas inlet and outlet of the fuel cell 100. Note that at least part of the functions of the control device 400 may be realized by a hardware circuit.

In the present disclosure, stopping the supply of the cathode gas and the anode gas to the fuel cell 100 in order to stop the power generation of the fuel cell 100 is referred to as stopping the fuel cell 100. Resuming the supply of the cathode gas and the anode gas to the fuel cell 100 to resume the power generation of the fuel cell 100 is referred to as restarting the fuel cell 100. When air flows into the anode gas internal channel 130 while the fuel cell 100 is stopped, the electrode catalyst layer on the anode side may deteriorate when the fuel cell 100 is restarted. If the anode inlet and outlet is not properly sealed, air may flow into the anode gas internal channel 130 from the anode inlet and outlet. If the cathode inlet and outlet is not properly sealed, air flowing into the cathode gas internal channel 120 from the cathode inlet and outlet may pass through the electrolyte membrane and flow into the anode gas internal channel 130. Therefore, it is preferable that the cathode gas inlet and outlet and the anode gas inlet and outlet of the fuel cell 100 are properly sealed while the fuel cell 100 is stopped.

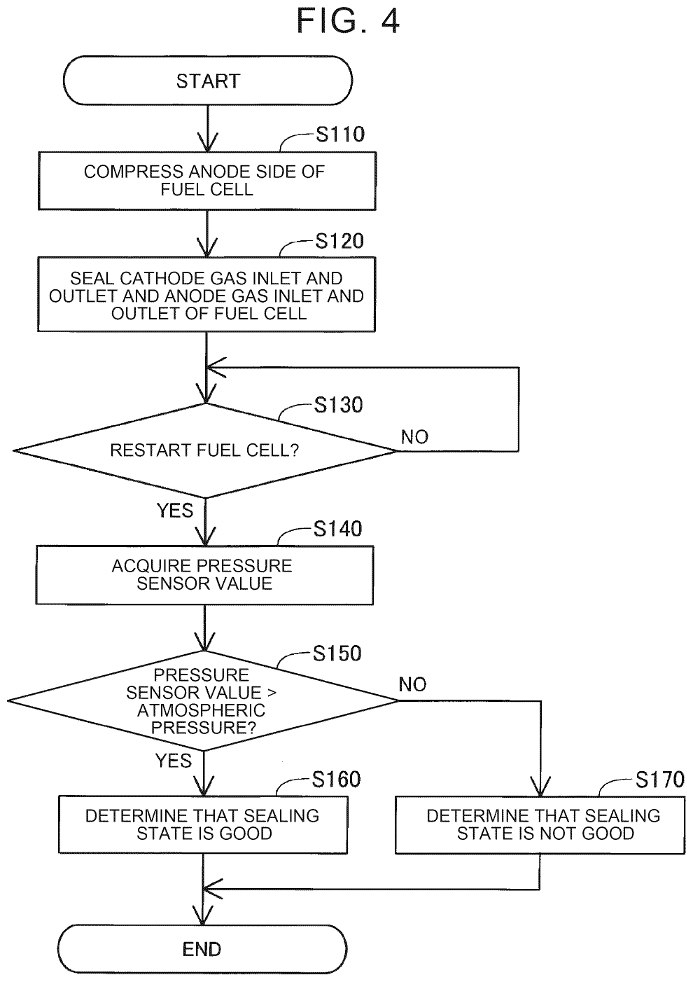

FIG. 4 is a flowchart illustrating a procedure of a diagnosis method for diagnosing a sealing state of a cathode gas inlet and outlet and an anode gas inlet and outlet of the fuel cell 100. This diagnostic method is started when the fuel cell 100 is stopped. In the present embodiment, the diagnostic method is executed by the processor 401 of the control device 400. At least part of the diagnostic method may be executed by a person.

In S110, the processor 401 pressurizes the anode gas internal channel 130 to a predetermined target pressure by supplying the anode gas to the anode gas internal channel 130 of the fuel cell 100 prior to stopping the fuel cell 100. In the present embodiment, the processor 401 pressurizes the anode gas internal channel 130 to the target pressure by supplying the anode gas from the anode gas tank 310 to the anode gas internal channel 130 in a state where the anode outlet valve 323 is closed. The target pressure is set to a pressure higher than the atmospheric pressure around the fuel cell system 10. The target pressure is set such that the internal pressure of the cathode gas internal channel 120 and the internal pressure of the anode gas internal channel 130 are sufficiently higher than the atmospheric pressure when the sealing state of the cathode gas inlet and outlet and the anode gas inlet and outlet is good and the internal pressure of the cathode gas internal channel 120 and the internal pressure of the anode gas internal channel 130 are in equilibrium. The target pressure can be determined, for example, based on the results of a pre-performed test.

In S120, the processor 401 seals the cathode gas inlet and outlet and the anode gas inlet and outlet of the fuel cell 100. In the present disclosure, sealing the cathode gas inlet and outlet means that the cathode gas internal channel 120 does not communicate with the atmosphere through the cathode gas inlet and outlet. Sealing the anode gas inlet and outlet means that the anode gas internal channel 130 is prevented from communicating with the atmosphere through the anode gas inlet and outlet. In this embodiment, the processor 401 seals the cathode gas inlet 121 by closing the cathode inlet valve 214, seals the cathode gas outlet 122 by closing the cathode outlet valve 222, and seals the anode gas inlet 131 and the anode gas outlet 132 by closing the anode outlet valve 323. In addition, the processor 401 closes the main stop valve 312 and the anode inlet valve 314 to prevent the anode gas from being supplied from the anode gas tank 310 to the anode gas inlet 131. The processor 401 keeps the cathode gas inlet and outlet and the anode gas inlet and outlet sealed from when the fuel cell 100 is stopped until the fuel cell 100 is restarted. In other words, the processor 401 keeps the cathode gas inlet and outlet and the anode gas inlet and outlet sealed while the fuel cell 100 is stopped. In the present embodiment, the fuel cell system 10 does not include a relay circuit that electrically shuts off the space between the fuel cell 100 and the load. Therefore, power generation of the fuel cell 100 can be continued until either or both of the cathode gas remaining in the cathode gas internal channel 120 and the anode gas remaining in the anode gas internal channel 130 are consumed, but power generation of the fuel cell 100 is stopped when either or both of the cathode gas remaining in the cathode gas internal channel 120 and the anode gas remaining in the anode gas internal channel 130 are consumed.

In S130, the processor 401 determines whether to restart the fuel cell 100. The processor 401 repeats S130 process until it is determined to restart the fuel cell 100.

When it is determined that the fuel cell 100 is to be restarted in S130, the processor 401 acquires the internal pressure of the anode gas internal channel 130 in S140. In the present embodiment, the processor 401 acquires the pressure measured by the pressure sensor 316 as the internal pressure of the anode gas internal channel 130. Since the pressure sensor 316 is disposed in the vicinity of the anode gas inlet 131, the pressure measured by the pressure sensor 316 can be used as the internal pressure of the anode gas internal channel 130. In the following description, the pressure measured by the pressure sensor 316 is referred to as a pressure sensor value. The pressure sensor value may be expressed in absolute pressure or in gauge pressure.

In S150, the processor 401 compares the pressure sensor value to the atmospheric pressure to determine whether the pressure sensor value is higher than the atmospheric pressure. In this embodiment, the processor 401 obtains the atmospheric pressure measured by the atmospheric pressure sensor 340 and compares the pressure sensor value to the atmospheric pressure measured by the atmospheric pressure sensor 340. When it is determined in S150 that the pressure sensor value is higher than the atmospheric pressure, the processor 401 determines in S160 that the sealing state of the cathode gas inlet and outlet and the anode gas inlet and outlet are good. When it is determined in S150 that the pressure sensor value is not higher than the atmospheric pressure, the processor 401 determines in S170 that the sealing state of the cathode gas inlet and outlet and the anode gas inlet and outlet is not good. After S160 or S170, the processor 401 ends the process. In the present embodiment, when it is determined that the sealing state of the cathode gas inlet and outlet and the anode gas inlet and outlet is good, the processor 401 executes the restart of the fuel cell 100. When it is determined that the sealing state of the cathode gas inlet and outlet and the anode gas inlet and outlet is not good, the processor 401 stops the restart of the fuel cell 100 without executing the restart.

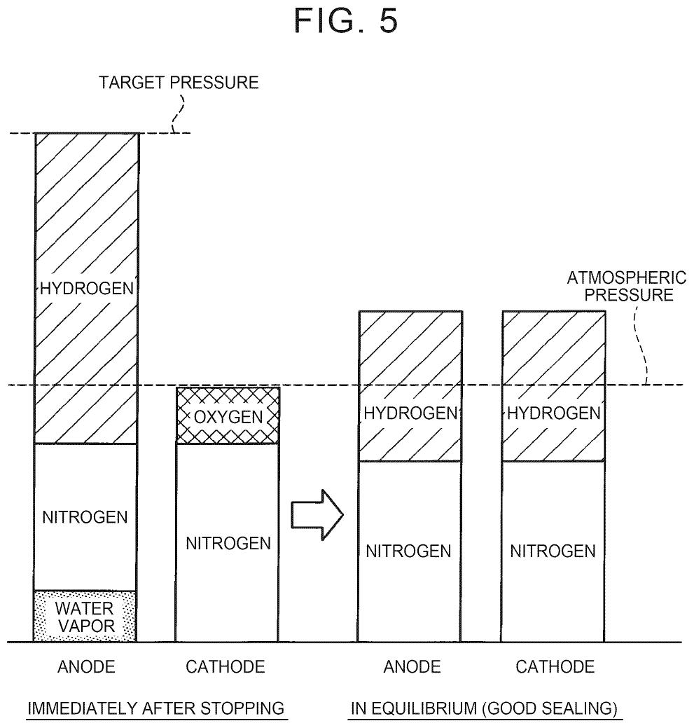

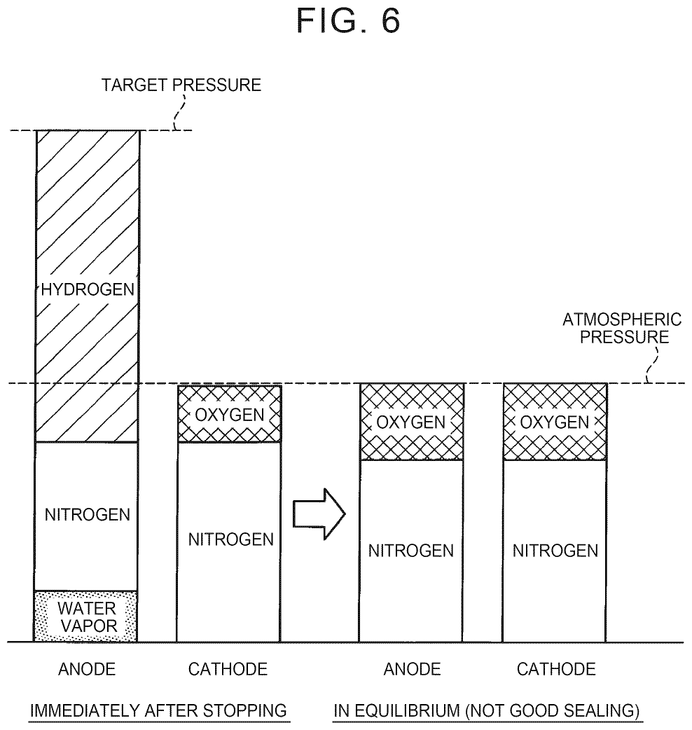

FIG. 5 is an illustration showing the internal pressure of the fuel cell 100 in a case where the sealing state of the cathode gas inlet and outlet and the anode gas inlet and outlet of the fuel cell 100 are good. FIG. 6 is an illustration showing the internal pressure of the fuel cell 100 when the sealing state of the cathode gas inlet and outlet and the anode gas inlet and outlet of the fuel cell 100 is not good. FIGS. 5 and 6 show the internal pressure of the cathode gas internal channel 120 and the internal pressure of the anode gas internal channel 130 immediately after the fuel cell 100 is stopped, and the internal pressure of the cathode gas internal channel 120 and the internal pressure of the anode gas internal channel 130 that are in equilibrium. As shown in FIGS. 5 and 6, immediately after the fuel cell 100 is stopped, the internal pressure of the anode gas internal channel 130 is higher than the atmospheric pressure by supplying the anode gas from the anode gas tank 310 before the fuel cell 100 is stopped. On the other hand, the internal pressure on the cathode gas internal channel 120 side is the same pressure as the atmospheric pressure when the compressor 213 is stopped.

As shown in FIG. 5, when the sealing state of the cathode gas inlet and outlet and the anode gas inlet and outlet is good, the oxygen in the air enclosed in the cathode gas internal channel 120 and the hydrogen enclosed in the anode gas internal channel 130 are consumed while the fuel cell 100 is stopped, so that the oxygen partial pressure in the cathode gas internal channel 120 and the hydrogen partial pressure in the anode gas internal channel 130 are reduced. Once sufficient time has elapsed, all of the oxygen in the cathode gas internal channel 120 is consumed. A portion of hydrogen remaining in the anode gas internal channel 130 passes through the electrolyte membrane and flows into the cathode gas internal channel 120, and a portion of nitrogen remaining in the cathode gas internal channel 120 passes through the electrolyte membrane and flows into the anode gas internal channel 130. As a result, in this equilibrium state, hydrogen and nitrogen remain in the cathode gas internal channel 120 and the anode gas internal channel 130, and the internal pressure of the cathode gas internal channel 120 and the internal pressure of the anode gas internal channel 130 are higher than the atmospheric pressure.

As shown in FIG. 6, for example, when a failure occurs in which either or both of the cathode inlet valve 214 and the cathode outlet valve 222 are unable to be closed, or when either or both of the seal members of the cathode inlet valve 214 and the cathode outlet valve 222 are deteriorated, the sealing state of the cathode gas inlet and outlet is not good, and the cathode gas internal channel 120 communicates with the atmosphere. In this case, even if oxygen enclosed in the cathode gas internal channel 120 is consumed, oxygen in the atmosphere is supplied to the cathode gas internal channel 120. Once sufficient time has elapsed, all of the hydrogen in the anode gas internal channel 130 is consumed. A portion of the air in the cathode gas internal channel 120 passes through the electrolyte membrane and flows into the anode gas internal channel 130. As a result, in the equilibrium state, oxygen and nitrogen remain in the cathode gas internal channel 120 and the anode gas internal channel 130, and the internal pressure of the cathode gas internal channel 120 and the internal pressure of the anode gas internal channel 130 are the same as the atmospheric pressure.

According to the fuel cell system 10 of the present embodiment described above, the processor 401 of the control device 400 pressurizes the anode gas internal channel 130 to a target pressure higher than the atmospheric pressure by supplying the anode gas to the anode gas internal channel 130 of the fuel cell 100 before the fuel cell 100 is stopped. The processor 401 of the control device 400 seals the cathode gas inlet and outlet and the anode gas inlet and outlet of the fuel cell 100 while the fuel cell 100 is stopped. The processor 401 of the control device 400 determines whether the sealing state of the cathode gas inlet and outlet and the anode gas inlet and outlet is good by comparing the internal pressure of the anode gas internal channel 130 with the atmospheric pressure before restarting the fuel cell 100. Therefore, the sealing state of the cathode gas inlet and outlet and the anode gas inlet and outlet of the fuel cell 100 can be correctly and easily diagnosed.

Further, in the present embodiment, the target pressure is set such that the internal pressure of the cathode gas internal channel 120 and the internal pressure of the anode gas internal channel 130 are higher than the atmospheric pressure when the sealing state of the cathode gas inlet and outlet and the anode gas inlet and outlet is good and the internal pressure of the cathode gas internal channel 120 and the internal pressure of the anode gas internal channel 130 are in equilibrium. Therefore, it is possible to suppress erroneous determination that the sealing state is not good even though the sealing state is actually good.

Further, in the present embodiment, it is possible to diagnose the sealing state of the cathode gas inlet and outlet and the anode gas inlet and outlet by comparing the pressure measured by the pressure sensor 316 used for the operation of the fuel cell 100 with the atmospheric pressure. Therefore, it is possible to diagnose the sealing state of the cathode gas inlet and outlet and the anode gas inlet and outlet without using other sensors such as a concentration sensor, a flow rate sensor, and a temperature sensor. Therefore, it is possible to suppress an increase in the number of components of the fuel cell system 10.

### B. Other Embodiments

In the fuel cell system 10 of the first embodiment described above, the pressure sensor 316 is provided in a portion of the anode gas supply channel 311 between the ejector 315 and the anode gas inlet 131. In contrast, the pressure sensor 316 may be provided in a portion of the anode off-gas discharge channel 321 between the anode gas outlet 132 and the gas-liquid separator 322.

In the fuel cell system 10 of the first embodiment described above, the processor 401 of the control device 400 compares the pressure measured by the pressure sensor 316 with the atmospheric pressure measured by the atmospheric pressure sensor 340 to determine whether the sealing state of the cathode gas inlet and outlet and the anode gas inlet and outlet is good. In contrast, the atmospheric pressure sensor 340 may not be provided in the fuel cell system 10. For example, the processor 401 may acquire weather information from the outside of the fuel cell system 10 using a communication device or the like, and compare the pressure measured by the pressure sensor 316 with the atmospheric pressure included in the weather information to determine whether the sealing state of the cathode gas inlet and outlet and the anode gas inlet and outlet is good. In this case, the fuel cell system 10 may not include the atmospheric pressure sensor 340.

The present disclosure is not limited to the embodiments above, and can be implemented with various configurations without departing from the scope of the present disclosure. For example, the technical features of the embodiments corresponding to the technical features in each mode described in the section “SUMMARY” may be replaced or combined appropriately to solve part or all of the above issues or to achieve part or all of the above effects. When the technical features are not described as essential in this specification, the technical features can be deleted as appropriate.

What is claimed is:

1. A method for diagnosing a sealing state of a fuel cell, the method comprising:
before stopping the fuel cell, compressing inside of the fuel cell to a predetermined pressure higher than an atmospheric pressure by supplying an anode gas to the fuel cell;
while the fuel cell is stopped, maintaining the sealing state in which an anode gas inlet and outlet of the fuel cell and a cathode gas inlet and outlet of the fuel cell are sealed; and
determining whether the sealing state is good by comparing a pressure inside the fuel cell measured before restarting the fuel cell with the atmospheric pressure.

2. The method according to claim 1, wherein:
the predetermined pressure is such a pressure that a pressure of a cathode gas internal channel and a pressure of an anode gas internal channel are higher than the atmospheric pressure when the sealing state is good and the pressure of the cathode gas internal channel and the pressure of the anode gas internal channel are in equilibrium, the cathode gas internal channel and the anode gas internal channel being channels provided inside the fuel cell;
when the pressure inside the fuel cell measured before restarting the fuel cell is higher than the atmospheric pressure, determination is made that the sealing state is good; and
when the pressure inside the fuel cell measured before restarting the fuel cell is not higher than the atmospheric pressure, determination is made that the sealing state is not good.

3. A fuel cell system comprising:
a fuel cell;
an anode gas supply source configured to supply an anode gas to the fuel cell;
a plurality of valves configured to seal an anode gas inlet and outlet of the fuel cell and a cathode gas inlet and outlet of the fuel cell;
a pressure sensor configured to measure a pressure inside the fuel cell; and
a control device configured to control the valves, wherein the control device is configured to
before stopping the fuel cell, compress inside of the fuel cell to a predetermined pressure higher than an atmospheric pressure by supplying the anode gas from the anode gas supply source to the fuel cell,
while the fuel cell is stopped, close the valves to maintain a sealing state in which the anode gas inlet and outlet of the fuel cell and the cathode gas inlet and outlet of the fuel cell are sealed, and
determine whether the sealing state is good by comparing the pressure inside the fuel cell measured with the pressure sensor before restarting the fuel cell with the atmospheric pressure.
